(19) United States
(12) Patent Application Publication
(10) Pub. No.: US 2014/0333867 A1
(43) Pub. Date: Nov. 13, 2014

(54) LIQUID CRYSTAL DISPLAY AND MOLD FRAME THEREOF

(71) Applicant: Yanxue Zhang, Shenzhen City (CN)

(72) Inventor: Yanxue Zhang, Shenzhen City (CN)

(73) Assignee: Shenzhen China Star Optoelectronics Technology Co., Ltd., Shenzhen City, Guangdong (CN)

(21) Appl. No.: 14/001,916

(22) PCT Filed: Jun. 25, 2013
(86) PCT No.: PCT/CN2013/077904

§ 371 Date: Aug. 28, 2013

(30) Foreign Application Priority Data
May 7, 2013 (CN) 201310164437.4

(51) Int. Cl. G02F 1/1333

(52) U.S. Cl. CPC G02F 1/133308
USPC 349/58

(57) ABSTRACT

The invention provides a liquid crystal display (LCD), which includes: mold frame, back plate, optical plate, at least an optical film and LCD panel; wherein optical plate disposed on top of back plate; optical film disposed on top of optical plate; mold frame pressing optical film to fix optical plate and optical film; mold frame including at least a frame border and a plurality of vacuum tubes, wherein vacuum tubes having first port disposed at frame border; LCD panel disposed at frame border and covering first port; air inside vacuum tubes being sucked out through second port of vacuum tubes to fix LCD panel by adsorption. LCD uses the vacuum tubes disposed on mold frame to fix LCD panel by adsorption to realize borderless design. The adsorption operation is simply and can lessen possibility of breakage when LCD panel expands or shrinks to improve yield rate and competitiveness.

### BACKGROUND OF THE INVENTION

1. Field of the Invention

The present invention relates to the field of liquid crystal display techniques, and more particularly to a liquid crystal display and mold frame thereof.

2. The Related Arts

Because the liquid crystal display (LCD) provides the advantages of light weight, reduced thickness, and low power consumption, the liquid crystal display finds wide applications in the many fields. The known LCD is mostly backlight-type LCD, which comprises a backlight module, a liquid crystal display panel and a frame, wherein the frame and the backlight module are fixedly connected to fix the liquid crystal display panel to the backlight module. The backlight module provides the light source of uniform luminance to the liquid crystal display panel so that the liquid crystal display panel can display images.

As manufacturing technology for the liquid crystal display improves, the borderless LCD becomes a trend. However, in the known design of the borderless LCD, the liquid crystal display panel usually uses two approaches to realize the fixation of the liquid crystal display panel. The first approach is to adhere the liquid crystal display panel, such as, by gluing, to the mold frame or other component of the backlight module; and the second approach is to use an acrylic (PMMA) plate to cover and adhere the liquid crystal display panel to fix the liquid crystal display panel. However, a disadvantage of the first approach is the difficulty to remove the liquid crystal display panel after adhering to the mold frame or other component of the backlight module, which is a major problem for manufacturing and reprocessing. For the second approach, the problem is the difficulty to control the expansion and shrinkage of the liquid crystal display panel and the acrylic plate, which easily results in the breaking of the liquid crystal display panel.

### SUMMARY OF THE INVENTION

The technical issue to be addressed by the present invention is to provide a borderless liquid crystal display and mold frame thereof.

The present invention provides a mold frame for liquid crystal display, which comprises: at least a frame border and a plurality of vacuum tubes, wherein the vacuum tubes having a first port disposed at the frame border; a liquid crystal display panel of the liquid crystal display being disposed at the frame border and covering the first port; the air inside the vacuum tubes being sucked out through a second port of the vacuum tubes so as to fix the liquid crystal display panel by adsorption.

According to a preferred embodiment of the present invention, a casing is disposed at a location on a back plate of the liquid crystal display corresponding to the second port; and the casing is facing away from the frame border and sheathes over the second port.

According to a preferred embodiment of the present invention, a trench is disposed at the first port on the frame border, and the trench surrounds the first port.

According to a preferred embodiment of the present invention, the trench disposed each first port is connected.

According to a preferred embodiment of the present invention, the roughness of the surface on the frame border is no greater than 0.005.

The present invention provides a liquid crystal display, which comprises: a mold frame, a back plate; an optical plate, at least an optical film and a liquid crystal display panel; wherein the optical plate being disposed on top of the back plate; the optical film being disposed on top of the optical plate; and the mold frame fixedly pressing the optical film so as to fix the optical plate and the optical film; the mold frame comprising at least a frame border and a plurality of vacuum tubes, wherein the vacuum tubes having a first port disposed at the frame border; a liquid crystal display panel of the liquid crystal display being disposed at the frame border and covering the first port; the air inside the vacuum tubes being sucked out through a second port of the vacuum tubes so as to fix the liquid crystal display panel by adsorption.

According to a preferred embodiment of the present invention, a casing is disposed at a location on the back plate corresponding to the second port; and the casing is facing away from the frame border and sheathes over the second port.

According to a preferred embodiment of the present invention, a trench is disposed at the first port on the frame border, and the trench surrounds the first port.

According to a preferred embodiment of the present invention, the trench disposed each first port is connected.

According to a preferred embodiment of the present invention, the roughness of the surface on the frame border is no greater than 0.005.

The liquid crystal display and mold frame thereof according to the present invention uses the vacuum tubes disposed on the mold frame to fix the liquid crystal display panel by adsorption to realize the borderless design. The adsorption operation is simply and the mechanism can lessen the possibility of breakage when the liquid crystal display panel expands or shrinks so as to improve the yield rate and competitiveness.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a mold frame for liquid crystal display according to the embodiment of the present invention;

FIG. 2 is a cross-sectional view along the A-A direction of FIG. 1,

FIG. 3 is a partial cross-sectional view showing the liquid crystal display according to the embodiment of the present invention; and

FIG. 4 is a schematic view showing the structure of a mold frame for liquid crystal display according to another embodiment of the present invention.

### DETAILED DESCRIPTION OF THE PREFERRED EMBODIMENTS

The following describes the embodiments of the present invention in details. The embodiments are depicted in the drawings, wherein the same number indicates the same part. The following refers to the drawings and embodiments for detailed description of the present invention. In the following, to prevent the unnecessary details of commonly known structures and/or functions from cluttering the concept of the present invention, the details of commonly known structures and/or functions are omitted.

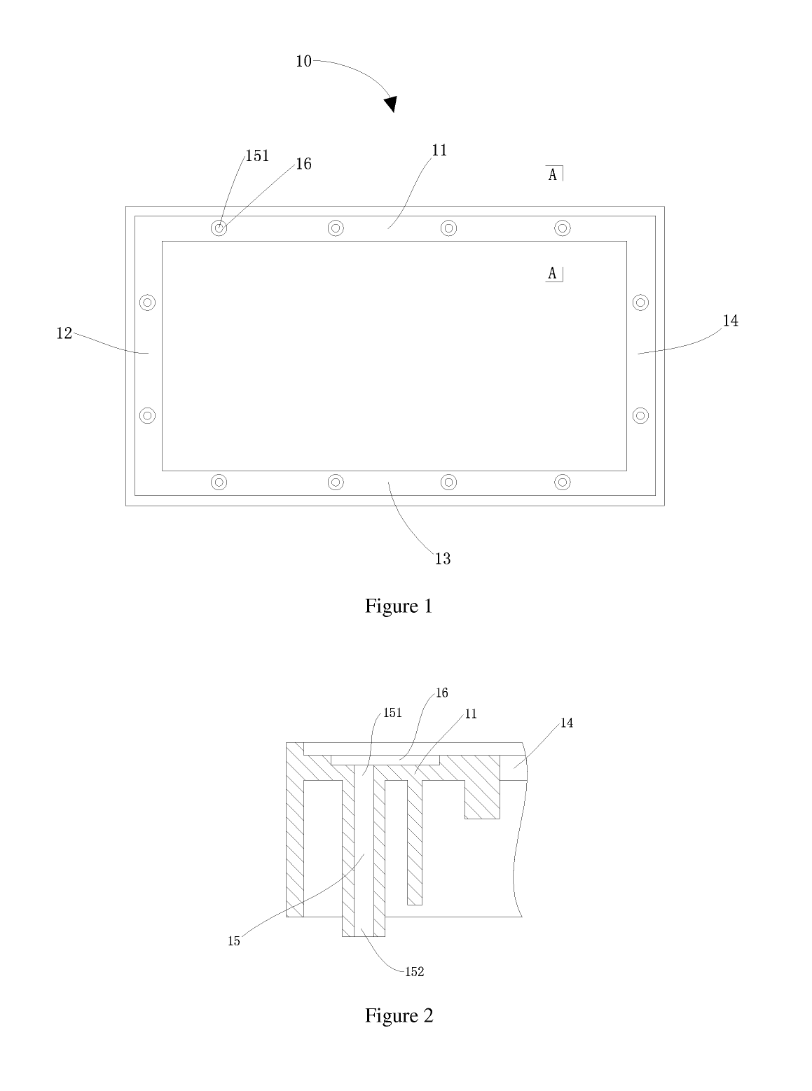

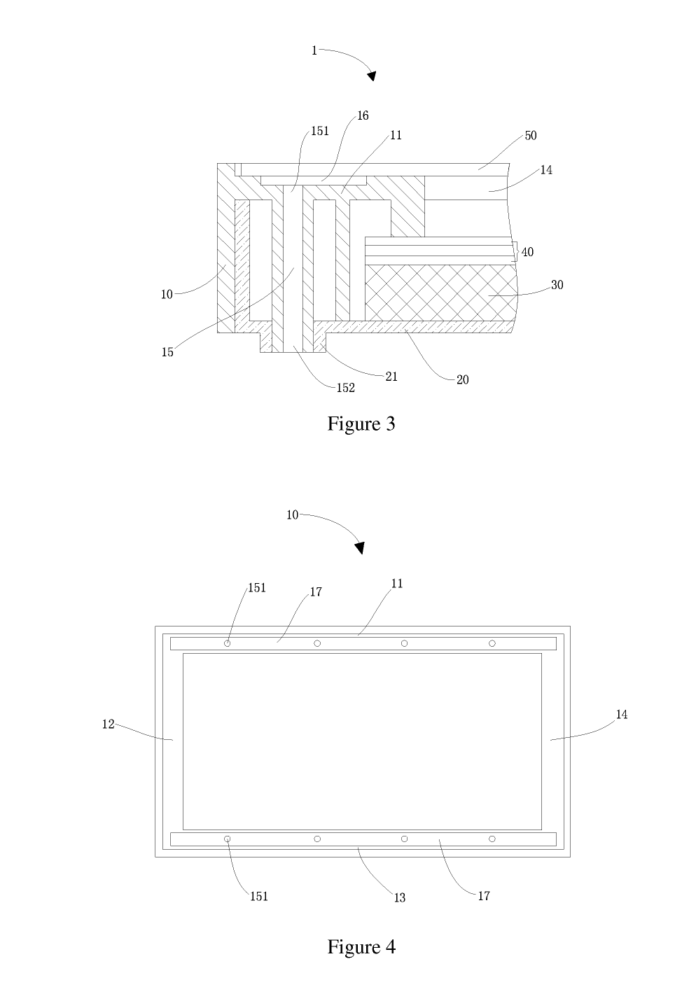

FIG. 1 is a schematic view showing the structure of a mold frame for liquid crystal display according to the embodiment of the present invention; FIG. 2 is a cross-sectional view along the A-A direction of FIG. 1; and FIG. 3 is a partial cross-sectional view showing the liquid crystal display according to the embodiment of the present invention. FIG. 3 uses the frame border of the mold frame in FIG. 2 as embodiment.

As shown in FIGS. 1-3, a liquid crystal display 1 according to the embodiment of the present invention comprises: a mold frame 10, a back plate 20, an optical plate 30, at least an optical film 40 and a liquid crystal display panel 50.

Depending on the disposition location of the light source (not shown), the optical plate 30 can be a diffuser or a light-guiding plate. The optical plate 30 is to transform the linear light transmitted by the light source into a uniform planar light source to provide to the liquid crystal display panel 50. The optical plate 30 is disposed on top of the back plate 20. The optical film is disposed on top of the optical plate 30. The mold frame 10 is connected and engaged to the back plate 20 and the mold frame 10 fixedly presses the optical film 40 so as to fix the optical plate 30 and optical film 40 onto the back plate 20.

The mold frame 10 for liquid crystal display 1 according to the embodiment of the present invention comprises four frame borders 11, 12, 13, 14 and a plurality of vacuum tubes 15. In the present invention, the number of the frame border of the mold frame 10 is not restricted to the embodiment in Figure, and can vary, such as, 1, 2, or 3.

Each vacuum tube 15 further comprises a first port 151 and a second port 152, disposed oppositely. In the instant embodiment, the opposite frame borders 11, 13 are each disposed with the first ports 151 of four vacuum tubes 15 respectively, and the opposite frame borders 12, 14 are each disposed with the first ports 151 of two vacuum tubes 15 respectively. It should be noted that the number of the first ports 151 disposed at each frame border is not restricted to the embodiment in FIG. 1. In addition, in the present invention, it is also possible to dispose the first port 151 at any one, two or three frame borders of the four frame borders.

The liquid crystal display panel 50 is disposed at each frame border and covers each first port 151. The air in each vacuum tube 15 is then sucked out from the second port 152 corresponding to the first port 151 of the vacuum tube 15 so as to fix the liquid crystal display panel 50 by adsorption.

To further facilitate sucking the air from the vacuum tubes 15 more easily in actual application, a casing 21 is disposed at the back plate 20 and the second port 152 of each vacuum tube 15. The casing 21 is disposed facing away from the liquid crystal display 1 and sheathes over the second port 152. As such, in actual operation, a connecting hose can be connected to the casing 21 and a vacuum device so that the vacuum device can easily suck the air out of the vacuum tube 15. Then, a mechanism, such as, a needle structure or a plug can be used to seal the second port 152 and the casing 21, leading to fixing the liquid crystal display panel 50 by adsorption. For reprocessing the liquid crystal display 1, the needle structure or the plug can be removed and the air is injected into the vacuum tube 15 to release the adsorption to the liquid crystal display panel 50, which simplifies the operation. In addition, the expansion or shrinkage of the liquid crystal display panel 50 can be realized by the movement of each frame border. During the movement, the liquid crystal display panel 50 always covers each first port 151. As a result, the liquid crystal display panel 50 is effectively fixed by adsorption and avoids breakage due to expansion or shrinkage.

To increase the adsorption area to the liquid crystal display panel 50, a trench is preferably disposed at each first port 151 on each frame border. The trench 16 surrounds the first port 151.

For further reducing the possibility of gap between the liquid crystal display panel 50 and the surfaces of the four frame borders 11, 12, 13, 14 and enhancing the tightness of adsorption, the surfaces of the four frame borders 11, 12, 13, 14 are preferably polished with a gloss process. In the instant embodiment, the surfaces of the four frame borders 11, 12, 13, 14 have a roughness no greater than 0.005 so that the surfaces of the frame borders are highly glossy.

FIG. 4 is a schematic view showing the structure of a mold frame for liquid crystal display according to another embodiment of the present invention.

Compared to the embodiment of FIG. 1, the embodiment of FIG. 4 disposes the first port 151 of four vacuum tubes 15 at the two opposite frame borders 11, 13 of the mold frame 10, and trenches disposed at each first port 151 of four vacuum tubes 15 are connected to form a large trench 17. In other words, the trench 17 formed respectively on the frame borders 11, 13 surrounds all the first ports 151 on respective frame border. The trench 17 allows a larger adsorption area with the liquid crystal display panel 50 to further fix the crystal display panel 50 more firmly.

It should be noted that the trench 17 can be disposed on any one, two, three or four frame borders and the number of first ports 151 surrounded by the trench 17 can also vary. The present invention is not restricted to the embodiment of FIG. 4.

In summary, the liquid crystal display and mold frame thereof according to the present invention uses the vacuum tubes disposed on the mold frame to fix the liquid crystal display panel by adsorption to realize the borderless design. The adsorption operation is simply and the mechanism can lessen the possibility of breakage when the liquid crystal display panel expands or shrinks so as to improve the yield rate and competitiveness.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A mold frame for liquid crystal display, which comprises: at least a frame border and a plurality of vacuum tubes, wherein the vacuum tubes having a first port disposed at the frame border; a liquid crystal display panel of the liquid crystal display being disposed at the frame border and covering the first port; the air inside the vacuum tubes being sucked out through a second port of the vacuum tubes so as to fix the liquid crystal display panel by adsorption.

2. The mold frame as claimed in claim 1, wherein a casing is disposed at a location on a back plate of the liquid crystal display corresponding to the second port; and the casing is facing away from the frame border and sheathes over the second port.

3. The mold frame as claimed in claim 1, wherein a trench is disposed at the first port on the frame border, and the trench surrounds the first port.

4. The mold frame as claimed in claim 2, wherein a trench is disposed at the first port on the frame border, and the trench surrounds the first port.

5. The mold frame as claimed in claim 3, wherein the trench disposed each first port is connected.

6. The mold frame as claimed in claim 4, wherein the trench disposed each first port is connected.

7. The mold frame as claimed in claim 1, wherein the roughness of the surface on the frame border is no greater than 0.005.

8. A liquid crystal display, which comprises: a mold frame, a back plate; an optical plate, at least an optical film and a liquid crystal display panel; wherein the optical plate being disposed on top of the back plate; the optical film being disposed on top of the optical plate; and the mold frame fixedly pressing the optical film so as to fix the optical plate and the optical film; the mold frame comprising at least a frame border and a plurality of vacuum tubes, wherein the vacuum tubes having a first port disposed at the frame border; a liquid crystal display panel of the liquid crystal display being disposed at the frame border and covering the first port; the air inside the vacuum tubes being sucked out through a second port of the vacuum tubes so as to fix the liquid crystal display panel by adsorption.

9. The liquid crystal display as claimed in claim 8, wherein a casing is disposed at a location on the back plate corresponding to the second port; and the casing is facing away from the frame border and sheathes over the second port.

10. The liquid crystal display as claimed in claim 8, wherein a trench is disposed at the first port on the frame border, and the trench surrounds the first port.

11. The liquid crystal display as claimed in claim 9, wherein a trench is disposed at the first port on the frame border, and the trench surrounds the first port.

12. The liquid crystal display as claimed in claim 10, wherein the trench disposed each first port is connected.

13. The liquid crystal display as claimed in claim 11, wherein the trench disposed each first port is connected.

14. The liquid crystal display as claimed in claim 8, wherein the roughness of the surface on the frame border is no greater than 0.005.
